(19) United States
(12) Patent Application Publication
(10) Pub. No.: US 2023/0109876 A1
(43) Pub. Date: Apr. 13, 2023

(54) INFORMATION PROCESSING APPARATUS, INFORMATION PROCESSING METHOD, AND METHOD OF MANUFACTURING PRODUCTS

(71) Applicant: CANON KABUSHIKI KAISHA, Tokyo (JP)

(72) Inventor: Wataru Kogushi, Kanagawa (JP)

(21) Appl. No.: 17/951,224

(22) Filed: Sep. 23, 2022

(30) Foreign Application Priority Data
Oct. 8, 2021 (JP) 2021-165899
Aug. 26, 2022 (JP) 2022-134897

(51) Int. Cl. B25J 9/16

(52) U.S. Cl. CPC B25J 9/1664

(57) ABSTRACT

An information processing apparatus includes an information processing portion and a route information map. The route information map is configured to include information on a route between a plurality of teach points for a motion of a robot. The information processing portion is configured to acquire a motion route of the robot leading to a target teach point, by using information on the target teach point to which the robot is to move, and the route information map.

### BACKGROUND OF THE INVENTION

### Field of the Invention

The present invention relates to an information processing method, an information processing apparatus, and the like.

### Description of the Related Art

In recent years, various types of robots, such as articulated robots, are widely used in various working processes in production lines, in which products are manufactured. In general, for causing a robot to perform work, the robot is taught a motion to be executed, and an operation program is stored in advance in a controller. The robot performs predetermined motion by a PLC sending a motion execution command or a motion permission signal to the controller.

By the way, in the production lines, there may be many cases in which after a robot is taught a predetermined motion and an operation program is stored in a controller, the motion that has been taught is required to be changed. For example, the motion is required to be changed if the possibility of unexpected interference between the robot and an object in the motion of the robot has been found, or if a process condition or the order of processes is changed due to the change of specifications of products.

In such cases, the operation program of the robot is required to be changed. For example, for changing a target position of the motion, not only a target teach point but also intermediate teach points, via which the robot moves, have to be set again. If a large number of man-hours is required for changing the operation program every time the motion is changed, the use of the robot may be restricted and the practicality will be lowered.

Japanese Pat. Application Publication No. 2006-154924 proposes a technique that programs a motion of a robot performed on a device mounted on each of a plurality of base stands. Specifically, the technique programs the motion of the robot, as a motion performed with respect to a reference position that is set in a corresponding base stand. The program is stored in a storage portion. If the motion of the robot is individually programmed for each operation task associated with a corresponding base stand, a user can select a program to be operated, depending on which base stand has a device on which the user desires the robot to perform work.

### SUMMARY OF THE INVENTION

According to a first aspect of the present invention, an information processing apparatus includes an information processing portion and a route information map. The route information map is configured to include information on a route between a plurality of teach points for a motion of a robot. The information processing portion is configured to acquire a motion route of the robot leading to a target teach point, by using information on the target teach point to which the robotis to move, and the route information map.

According to a second aspect of the present invention, an information processing method includes acquiring by an information processing portion, a motion route of a robot leading to a target teach point to which the robot is to move, by using information on the target teach point, and a route information map that includes information on a route between a plurality of teach points for a motion of the robot.

According to a third aspect of the present invention, a system includes a robot, an information processing apparatus including a route information map configured to include information on a route between a plurality of teach points for a motion of the robot, and a PLC configured to output information on a target teach point to which the robot is to move, to the information processing apparatus.

According to a fourth aspect of the present invention, an information processing apparatus includes an information processing portion, and a route information map configured to include information on a route between a plurality of teach points for a motion of a robot. The information processing portion is configured to display a motion route of the robot leading to a target teach point, on a display portion by using information on the target teach point to which the robot is to move, and the route information map.

According to a fifth aspect of the present invention, an information processing apparatus includes displaying, by an information processing apparatus, a motion route of a robot leading to a target teach point to which the robot is to move, on a display portion by using information on the target teach point, and a route information map that includes information on a route between a plurality of teach points for a motion of the robot.

Further features of the present invention will become apparent from the following description of exemplary embodiments with reference to the attached drawings.

### BRIEF DESCRIPTION OF THE DRAWINGS

FIG. 1 is a schematic diagram illustrating an example of a configuration of a control system that includes an information processing apparatus of an embodiment.

FIG. 2 is a diagram illustrating an example of a specific configuration of a control system of an embodiment.

FIG. 3 is a block diagram illustrating an example of a configuration of a robot control apparatus 200.

FIG. 4 is a schematic diagram for illustrating an example of teach points.

FIG. 5 is a schematic diagram for conceptually illustrating a route information map of an embodiment.

FIG. 6 is a diagram for illustrating a configuration of images displayed in a display screen of a route-information-map creation tool of an embodiment and for illustrating functions of the display screen.

FIG. 7 illustrates an example of a screen image displayed when a point information tab is selected.

FIG. 8 illustrates an example of a screen image displayed when a route information tab is selected.

FIG. 9 illustrates an example of a screen image displayed when a group setting tab is selected.

FIG. 10 is a flowchart for illustrating an information processing method (i.e., a motion control method of a robot) of an embodiment.

FIG. 11 illustrates an example of a screen image displayed when a motion-route determination mode is set.

FIG. 12 is a diagram illustrating one example of a created motion route.

FIG. 13 is a diagram for illustrating a return-to-origin motion.

FIG. 14 is a flowchart illustrating one example of an information processing procedure used for storing information, which indicates whether the movement from any teach point to an origin teach point is possible or not, in the route information map.

FIG. 15 is a flowchart illustrating information processing performed for executing the return-to-origin motion by using the route information map.

FIG. 16 is a schematic diagram illustrating an example of a configuration of a control system that includes an information processing apparatus of an embodiment.

FIG. 17 is a schematic diagram illustrating an example of a configuration of a control system that includes an information processing apparatus of an embodiment.

FIG. 18 is a diagram illustrating one example of a simulator of an embodiment.

FIG. 19 is a diagram illustrating one example of a teaching pendant of an embodiment.

FIG. 20 is a flowchart illustrating one example of an information processing procedure for acquiring cost information by using a robot simulator.

FIG. 21 is a flowchart illustrating one example of an information processing procedure for acquiring cost information by using a robot simulator.

FIG. 22 illustrates an example of a screen image displayed when a prohibited-pass-point setting tab is selected.

FIG. 23 is a schematic diagram for conceptually illustrating a route information map of an embodiment.

FIG. 24 is a schematic diagram for conceptually illustrating a route information map of an embodiment.

FIG. 25 is a schematic diagram illustrating an example of a configuration of a control system that includes an information processing apparatus of another embodiment.

FIG. 26 is a schematic diagram illustrating an example of a configuration of a control system that includes information processing apparatuses of an embodiment that control a plurality of robots.

### DESCRIPTION OF THE EMBODIMENTS

If a program is divided into components, as described in Japanese Pat. Application Publication No. 2006-154924, so that each component executes a corresponding operation task associated with a corresponding base stand, it becomes easy to changes the order of operation tasks or execute an operation task repeatedly, for example, by changing the arrangement of base stands.

However, in a case where not the order of operation tasks but an operation task itself, performed on a corresponding base stand, is required to be changed, the method described in Japanese Pat. Application Publication No. 2006-154924 is not applicable to the case. For example, even in the method described in Japanese Pat. Application Publication No. 2006-154924, if a target teach point and intermediate teach points, via which a robot moves to the target teach point, are required to be set again, the troublesome work will be necessary as in the conventional art.

For this reason, it has been desired to achieve an information processing method and an information processing apparatus that can easily set or change the motion of a robot.

Next, an information processing method and an information processing apparatus of an embodiment of the present invention will be described with reference to the accompanying drawings.

Note that since the embodiments described below are merely examples, detailed configurations thereof may be modified as appropriate by a person skilled in the art without departing the spirit of the present invention.

In addition, in the drawings that will be referred to in the description of the below-described embodiments and examples, a component given an identical reference numeral has an identical function, unless specified otherwise.

### First Embodiment

### Configuration of Control System

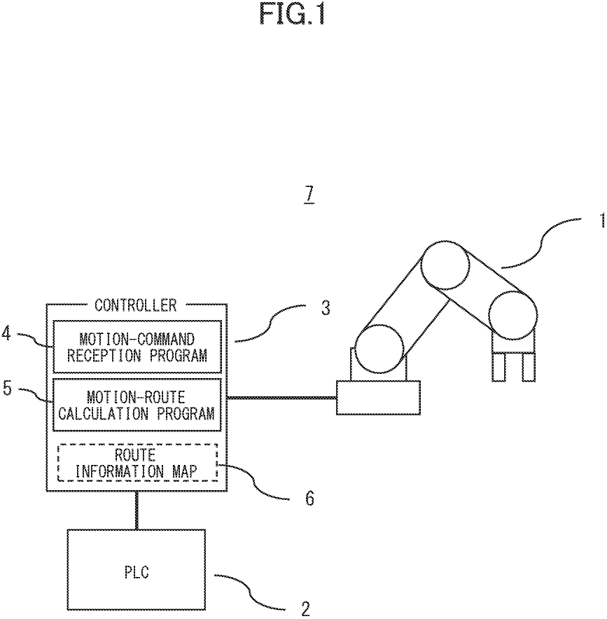

FIG. 1 is a schematic diagram for illustrating a configuration of a control system that includes an information processing apparatus of the present embodiment. A control system 7 includes a PLC 2 and a controller 3 for controlling a robot 1. The control system of the present embodiment is not limited to the example illustrated in FIG. 1. For example, the control system may have a configuration in which a single PLC controls a plurality of robots.

The PLC 2 is a programmable logic controller, and outputs information on a target position (referred to also as a target teach point) to the controller 3 in a sequential manner. The target position is a position to which the robot 1 will move in the next operation.

The controller 3 serves as an information processing apparatus, and is communicatively connected with the PLC 2 and the robot 1. The controller 3 includes a motion-command reception program 4, a motion-route calculation program 5, and a route information map 6. The motion-route calculation program 5 serves as an information processing portion.

When the controller 3 receives information on a target teach point from the PLC 2, the controller 3 starts the motion-route calculation program 5 (that serves as a motion-route calculation portion). The information on a current position (referred to also as a current teach point) of the robot 1 is stored in a storage portion of the controller 3. The motion-route calculation program 5 uses the route information map 6, and determines (acquires) a motion route for moving the robot 1 from the current teach point to the target teach point. The route information map 6 will be described in detail below. Note that the motion route determined may include a position (referred to also as an intermediate teach point) via which the robot 1 will move from the current teach pointto the target teach point.

After the motion-route calculation program 5, which serves as an information processing portion, determines a motion route, the controller 3, which serves as an information processing apparatus, creates a motion command for moving the robot 1 along the motion route. The motion command is created as a variable from a target teach point and motion parameters, in conformity with a rule. Since the motion command is created as a variable, the motion of the robot can be changed without changing a program. The motion parameters may include information on an interpolation method of motion, speed, acceleration, deceleration, and stopping accuracy; and can be set, associated with a corresponding route.

The motion-command reception program 4 interprets the created motion command; and causes the robot 1 to execute the motion command.

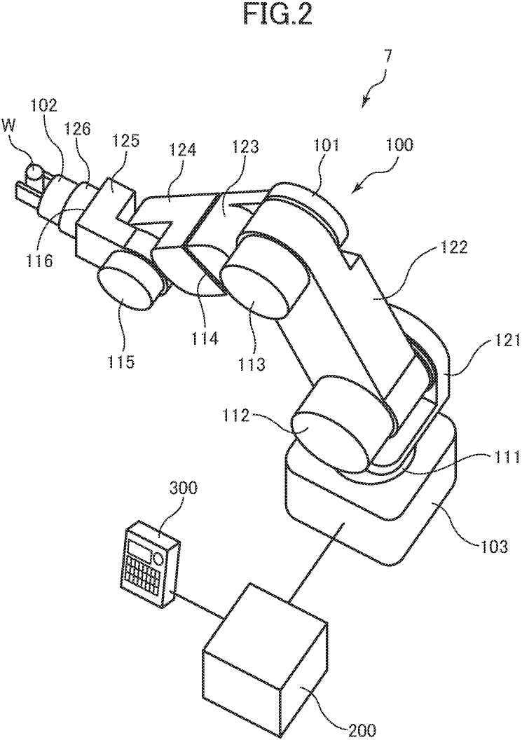

FIG. 2 illustrates a specific configuration of the control system 7. The type and the structure of the robot 1 illustrated in FIG. 1 are not limited to a particular type and a particular structure. For example, an articulated robot 100 illustrated in FIG. 2 is suitably used as the robot 1. In the control system 7 illustrated in FIG. 2, the articulated robot 100 is connected with a robot control apparatus 200, and the robot control apparatus 200 is connected with a teaching pendant 300 that sends teach data and the like. The teaching pendant 300 is a device that an operator uses, for example, when the operator teaches the robot control apparatus 200 a motion of the articulated robot 100. The robot control apparatus 200 includes the PLC 2 and the controller 3, which are illustrated in FIG. 1. The controller 3 serves as an information processing apparatus.

The articulated robot 100 includes a six-axis articulated robot arm 101, a robot hand 102, and a force sensor (not illustrated). The robot hand 102 is connected to the distal end of the robot arm 101, and serves as an end effector. The force sensor detects the force applied to the robot hand 102. For example, the articulated robot 100 connected with the robot control apparatus 200 is used as a product-manufacturing apparatus that holds a workpiece W and assembles the workpiece W to another component.

The robot arm 101 of the articulated robot 100 includes a base portion 103, a plurality of links 121 to 126, and a plurality of joints 111 to 116. The base portion 103 is fixed to a workbench; the plurality of links 121 to 126 transmit displacement and force; and the plurality of joints 111 to 116 join the links 121 to 126 with each other such that the links 121 to 126 can pivot or rotate.

The robot hand 102 includes a plurality of fingers that can hold a workpiece W, and an actuator (not illustrated) that drives the plurality of fingers. By driving the plurality of fingers, the robot hand 102 can hold the workpiece W.

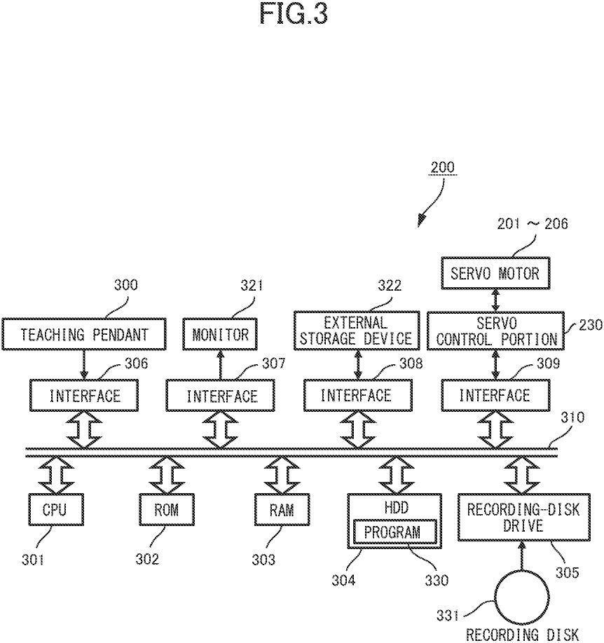

The robot control apparatus 200 includes the PLC 2 and the controller 3, which are illustrated in FIG. 1. One example of the configuration of the robot control apparatus 200 will be described with reference to a block diagram of FIG. 3. The robot control apparatus 200 is a computer, and includes a central processing unit (CPU) 301 that serves as a processing portion. In addition, the robot control apparatus 200 includes a read only memory (ROM) 302, a random access memory (RAM) 303, and a hard disk drive (HDD) 304, which serve as storage portions. In addition, the robot control apparatus 200 includes a recording-disk drive 305 and various interfaces 306 to 309.

The CPU 301 is connected with the ROM 302, the RAM 303, the HDD 304, the recording-disk drive 305, and the various interfaces 306 to 309, via a bus 310. The ROM 302 stores a base program such as a BIOS. The RAM 303 is a storage device that temporarily stores various types of data, such as results of a computing process performed by the CPU 301.

The HDD 304 is a storage device that stores results of a computing process performed by the CPU 301 and various types of data acquired from an external device; and stores a program 330 that causes the CPU 301 to execute a below-described computing process. The CPU 301 performs each process of a robot control method, depending on the program 330 recorded (stored) in the HDD 304.

The recording-disk drive 305 reads various types of data and a program stored in a recording disk 331.

The teaching pendant 300 is connected to the interface 306. The CPU 301 receives teach data from the teaching pendant 300, via the interface 306 and the bus 310.

A servo control portion 230 is connected to the interface 309. The CPU 301 acquires signals from servo motors 201 to 206, via the interface 309 and the bus 310. In addition, the CPU 301 outputs torque-command data for each joint, to the servo control portion 230, via the bus 310 and the interface 309, at predetermined time intervals.

The interface 307 is connected with a monitor 321, which displays various images under the control performed by the CPU 301. The interface 308 can be connected with an external storage device 322, such as a rewritable nonvolatile memory or an external HDD, that serves as a storage portion.

In the present embodiment, the description will be made for a case where the HDD 304 is a computer-readable recording medium and stores the program 330. However, the present disclosure is not limited to this. The program 330 may be recorded in any recording medium as long as the recording medium is a computer-readable recording medium. For example, the ROM 302, the recording disk 331, or the external storage device 322, which are illustrated in FIG. 3, may be used as the recording medium that provides the program 330. Specifically, a flexible disk, a hard disk, an optical disk, a magneto-optical disk, a DVD-ROM, a CD-ROM, a CD-R, a magnetic tape, a nonvolatile memory, an HDD, a ROM, or the like may be used as the recording medium.

### Route Information Map

Next, the route information map 6 included in the controller 3, which serves as an information processing apparatus, will be described. If a plurality of positions and postures (referred to also as teach points) that the robot 1 can take are set in advance, and the position information of the teach points can be used when an operator teaches the robot 1 a motion, the operator can efficiently teach the robot the motion.

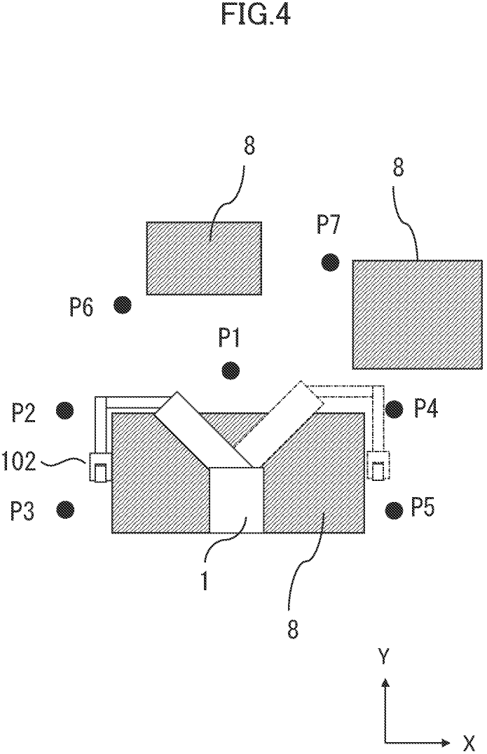

FIG. 4 is a schematic diagram for illustrating an example of teach points. In this example, seven teach points, P1 to P7, are set in advance as positions that the robot hand 102 of the robot 1, which serves as an end effector, can take. In addition, in an area in which the robot hand 102 can move, three objects 8 that may interfere with the robot hand 102 exist.

In general, a robot hand of a robot moves three-dimensionally. In the present disclosure, however, for simply describing the route information map 6, the model will be simplified and conceptually described. Specifically, each teach point is set in an X-Y plane, the robot hand 102 moves linearly between teach points in the X-Y plane, and the objects 8 exist in the X-Y plane. In addition, the other portions of the robot 1 except the robot hand 102 do not interfere with the obj ects 8.

For example, in a case where the robot hand 102 moves from a teach point P2 to a teach point P3, the objects 8 that may interfere with the robot hand 102 are not present on a route from the teach point P2 to the teach point P3. Thus, if the controller 3 receives from the PLC 2 a command for moving the robot hand 102 from the teach point P2 to the teach point P3, the controller 3 can adopt the route directly connecting the teach point P2 and the teach point P3, as a motion route.

In contrast, in a case where the robothand 102 is moved from the teach point P3 to a teach point P1, an object 8 that may interfere with the robot hand 102 is present on a route that linearly connects the teach point P3 and the teach point P1. Thus, if the controller 3 receives from the PLC 2 a command for moving the robot hand 102 from the teach point P3 to the teach point P1, the controller 3 cannot adopt the route directly connecting the teach point P3 and the teach point P1, as a motion route.

As described above, in a case where the robot hand 102 is to be moved from one teach point to another teach point, a route directly connecting two teach points may or may not be adopted, as a motion route. Note that the above-described model is a simplified model. In addition, the robot hand can move three-dimensionally in actuality, and it is necessary to consider that another portion (e.g., the arm) of the robot other than the robot hand may interfere with an object. Even in such a case, it can be easily understood that a route directly connecting any two teach points may or may not be adopted as a motion route. With such an assumption, the route information map will be described.

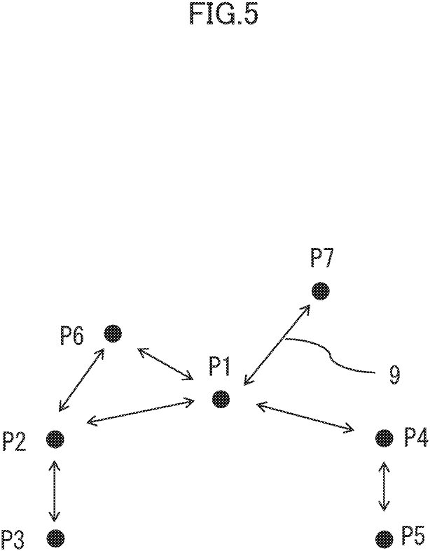

FIG. 5 is a schematic diagram for conceptually illustrating the route information map 6. The route information map 6 includes information on whether a route directly connecting any two teach points can be adopted as a motion route when the robot hand 102 is to be moved from one of the two teach points to the other. Two teach points freely-selected from the teach points P1 to P7 are referred to as a first teach point and a second teach point. In FIG. 5, whether a route directly connecting the freely-selected first and second teach points can be adopted as a motion route when the robot hand 102 is to be moved from the first teach point to the second teach point is indicated by the presence of an arrow line 9. If a route can be adopted as a motion route, the arrow line 9 heading from the first teach point toward the second teach point is shown. In contrast, if a route cannot be adopted as a motion route, the two teach points are not connected with each other by the arrow line 9.

Note that the model of FIG. 4 is simplified as described previously. Thus, if the robot hand 102 can move directly from the first teach point to the second teach point, the robot hand 102 can also move from the second teach point to the first teach point. For this reason, the arrow line 9 illustrated in FIG. 5 is a double-headed arrow line. In a real system, however, even if the robothand can move directly from the first teach point toward the second teach point, the robot hand may not be able to move from the second teach point toward the first teach point due to the characteristics of the machine (or because a user desires to forbid the movement in the reverse direction). In such a case, only an arrow line heading from the first teach point toward the second teach point is shown in the route information map. In this manner, the route information map includes the information on the moving direction defined between teach points.

In FIGS. 4 and 5, the model in which the seven teach points are set is illustrated for simplifying the description. In actuality, however, more teach points are often used. Also in such a case, the route information map can include information on whether a combination of any two teach points, selected from preset many teach points, can be adopted as a motion route (that is, the route information map can include information of all combinations of two points, on whether each combination can be adopted as a motion route). However, there may be a case in which some combinations of teach points are actually impossible in the teaching operation, for example, due to the work to be performed by the robot, characteristics of the robot, or the arrangement of objects. In such a case, it is preferable to create the route information map by removing combinations of teach points, which are impossible in the actual teaching operation, from all combinations from which any two teach points are selected. This is performed for reducing the man-hours required for creating the route information map, the memory capacity required for storing the route information map, and the amount of information processing performed by the motion-route calculation program 5 for determining a motion route.

In addition, in the example illustrated in FIGS. 4 and 5, in a case where a command instructing that the next destination (target teach point) is P1 is issued from the PLC 2 when the current position of the robot hand 102 is P3, there is a plurality of motion routes that can be adopted. Specifically, a motion route: P3 → P2 → P1 and a motion route: P3 → P2 → P6 → P1 can be adopted. The route information map includes cost information (referred to also as evaluation information) on time required for movement, movement distance (motion distance), energy required for movement, peak current, and the like, for each of the routes that can be adopted as a motion route. Since the route information map includes the cost information, an optimum motion route can be determined by the motion-route calculation program 5, on a basis of selection, such as a basis on which the priority is given to time or a basis on which the priority is given to energy consumption. Note that if the model information on the mechanism and characteristics of the robot is stored in advance in the controller 3, the information processing apparatus may use the model information, and automatically create the cost information (evaluation information) and register the cost information in the route information map 6 when creating the route information map 6.

In FIG. 5, the route information map is illustrated in a diagram format. However, the above-described information may be stored in a storage portion of the controller 3 in any format, and thereby the route information map may be created as a database. The diagram format illustrated in FIG. 5 is suitably used, for example, when the route information map is displayed on a display screen (display portion) of a user interface or printed, for allowing an operator to intuitively understand the contents of the route information map. The route information map can be created, stored, edited, displayed, and printed in various formats, including a list format and a table format, other than the diagram format.

### Route-Information-Map Creation Tool

The information processing apparatus of the present embodiment includes a route-information-map creation tool used for creating and editing the route information map. The route-information-map creation tool is stored in the robot control apparatus 200, as a program; and a user can start and operate the route-information-map creation tool by using the teaching pendant 300, for example. Note that the route-information-map creation tool may be operated by a user by using an input/output unit other than the teaching pendant 300. In another case, the route-information-map creation tool is stored in an external computer, not in the robot control apparatus 200; and a route information map, created by a user by using the external computer, may be stored in the robot control apparatus 200.

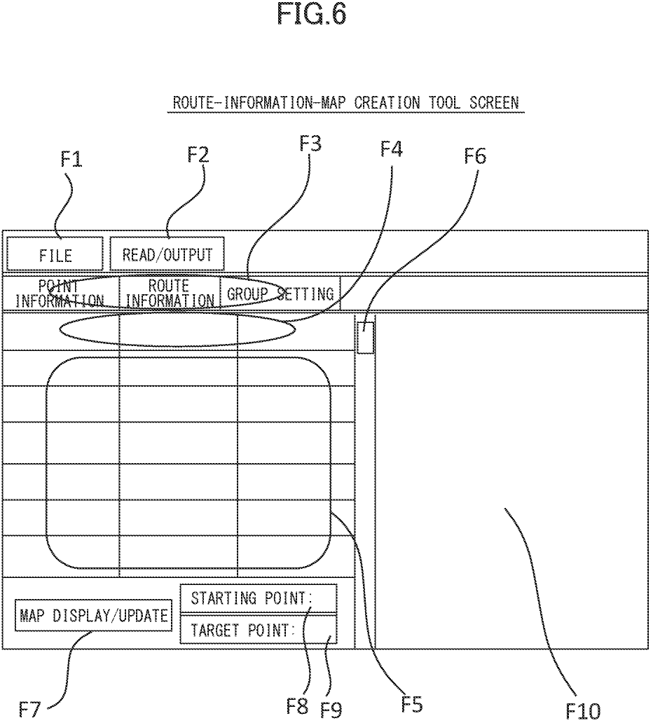

FIGS. 6 to 9 illustrate examples of images displayed on a display screen of a user interface when a user operates the route-information-map creation tool. Note that since the images have only to be convenient for a user to create, edit, and check the route information map, the images are not necessarily limited to the examples illustrated in FIGS. 6 to 9. For example, the display item, the display format, and the screen configuration may be changed as appropriate.

FIG. 6 is a diagram for illustrating a configuration of images displayed in a display screen of the route-information-map creation tool and for illustrating functions of the display screen. The display screen is configured so that a user can easily check and edit the information on teach points and a motion route included in the route information map.

A button F1 is used for specifying a file of the route information map when the file is created, opened, saved, or restored by a user.

A button F2 is used for outputting a file to an external device or reading a file from an external device. For example, the button F2 is used for reading cost information calculated by using a robot simulator or reading cost information that was set by a user by using an external device.

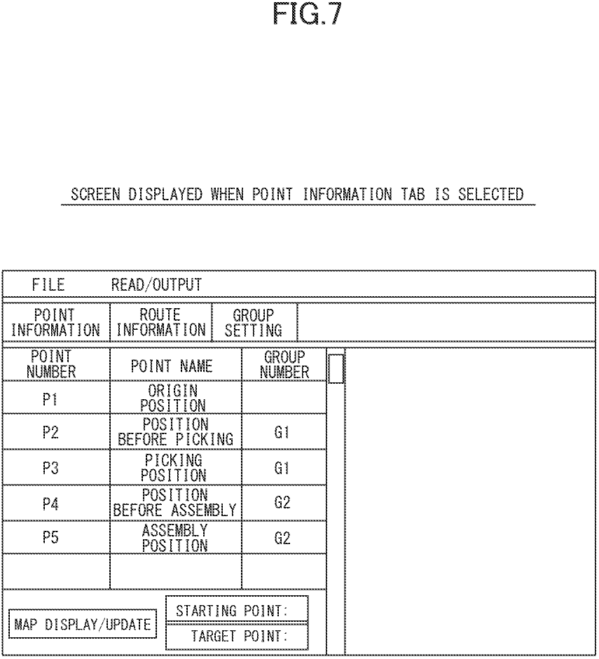

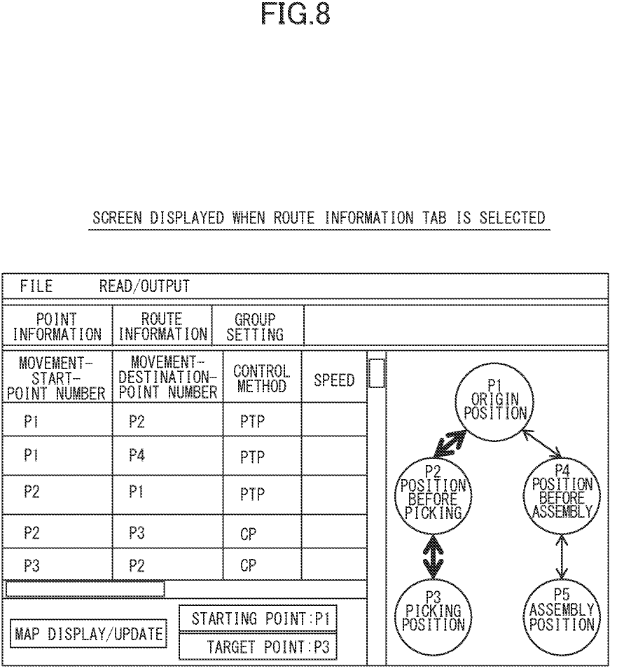

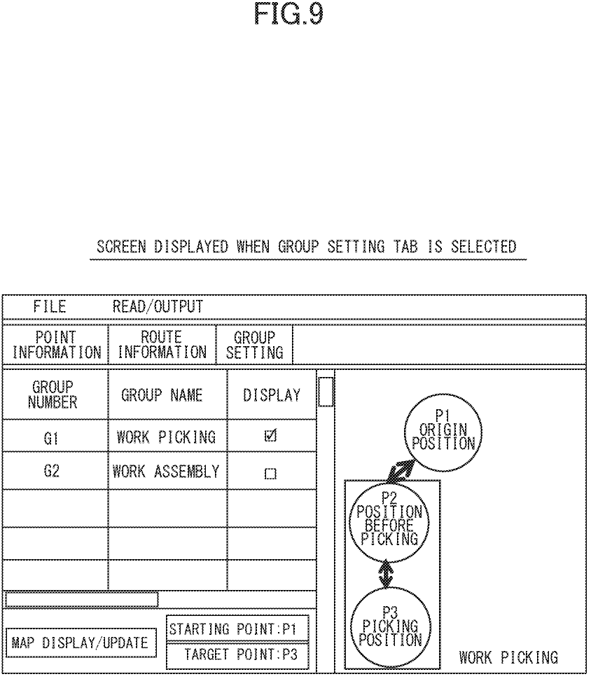

A tab F3 is used for selecting a screen format when the information included in the route information map is displayed for user operation. For example, a screen image illustrated in FIG. 7 is selected when a user selects a point information tab, a screen image illustrated in FIG. 8 is selected when a user selects a route information tab, and a screen image illustrated in FIG. 9 is selected when a user selects a group setting tab.

An item display field F4 is a field in which data items (types) for data to be inputted or edited are displayed.

A data display field F5 is a field in which the data having been inputted or edited is displayed.

A scroll key F6 is used for scrolling the data column displayed in the data display field F5. Note that if there are many data items (types) and the data display field F5 is long in a horizontal direction, not only the vertical-scroll key illustrated in FIG. 6 but also a horizontal-scroll key may be disposed as illustrated in FIGS. 8 and 9.

A button F7 is used for displaying the motion route information, which is to be edited, in a map display field F10 as a diagram. The button F7 is also used for updating the diagram displayed in the map display field 10, in accordance with data that has been edited.

An input field F8 is a field in which a user puts a teach point (starting point) that is a start point of a motion route to be edited or displayed in the diagram.

An input field F9 is a field in which a user puts a teach point (target point) that is an end point of a motion route to be edited or displayed in the diagram.

The map display field F10 is a field in which the motion route information is displayed as a diagram.

Hereinafter, display screens used by a user for performing work will be specifically described as examples.

FIG. 7 illustrates an example of a screen image displayed when the point information tab is selected by a user in the tab F3 (FIG. 6) used for selecting a screen format. The information used in the screen is information for explanation that is referred to when a route information map is displayed as a diagram, and that is not information directly used for controlling an actual robot. A point number is an identification number given for individually identifying a registered teach point. A point name is a name given to a corresponding teach point for allowing a user to easily understand the work of the robot performed at the teach point. A group number is a number given for individually identifying a set (group) of two teach points. In other words, the group number is a route identification number for individually identifying a route that connects the two teach points.

In the display screen illustrated in FIG. 7, a route G1 is set between a teach point P2 and a teach point P3 for moving the robot hand in picking work, and a route G2 is set between a teach point P4 and a teach pointP5 for moving the robot hand in assembly work.

FIG. 8 illustrates an example of a screen image displayed when the route information tab is selected by a user in the tab F3 (FIG. 6) used for selecting a screen format. The information used in the screen image is information required to be inputted for creating (acquiring) a route information map. A movement-start-point number is an identification number (point number) of a teach point that is a start point of a route. A movement-destination-point number is an identification number (point number) of a teach point that is a destination of a route. A control method is a motion control method used for moving the robot along a route from the movement start point to the movement destination point. The field for the control method includes information on continuous path (CP) control, point-to-point (PTP) control, and the like. Note that the CP control is a control method for moving a robot under the linear interpolation control. Since the CP control causes each shaft of the robot to move while performing interpolation, the distal end of the arm can move from current coordinates to target coordinates in the shortest distance. In addition, the PTP control is a control method that allows the shortest motion time. The PTP control is a method in which the importance is placed on the position and posture of the robot at the start point and the end point, and the route of movement depends on the posture of the robot. Thus, the robot cannot perform the linear movement in principle.

The screen image displayed when the route information tab is selected may include information on specific control parameters, in addition to the above-described information, that are used for moving the robot along the route. Examples of the control parameters include parameters on speed, acceleration, deceleration, and stopping accuracy, which are used for the motion of the robot.

FIG. 9 illustrates an example of a screen image displayed when the group setting tab is selected by a user in the tab F3 (FIG. 6) used for selecting a screen format. The screen image is used for a user to set or edit a motion route connecting two teach points, and is displayed for a user to check the motion route. A group number displayed in the screen image is identical to a group number displayed in the screen image (FIG. 7) selected by using the point information tab. A group name is a name given for a user to easily identify a corresponding group (motion route). For example, the group name is named after a role of the route performed in the work. A display field includes a check box for setting whether a corresponding group (motion route) is displayed in the map display field F10, which is displayed in a right portion of the screen image.

The route-information-map creation tool can select and display each of the screen images, so that a user can easily create or edit a route information map. For example, on a screen image displayed by selecting the point information tab, a user can give a teach point a name that allows the user to easily understand the work performed at the teach point. In addition, on a screen image displayed by selecting the route information tab, a user can set a route, and associate the route with a control method and motion parameters and check the association. On a screen image displayed by selecting the point information tab and a screen image displayed by selecting the group setting tab, a user can set support information, if necessary, that is included in the route information map when the route information map is displayed as a diagram. For example, a user can set a point name so as to be displayed at a corresponding teach point in the map display field F10 when the route information map is displayed as a diagram. After creating editing, and checking the route information map in this manner, a user can output the route information map by using an output function of the route-information-map creation tool, in a data format that allows the route information map to be stored in the controller 3.

### Information Processing Method

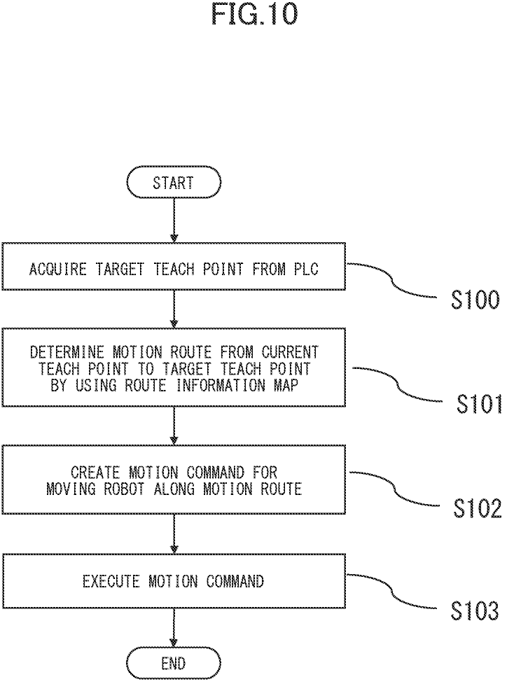

FIG. 10 is a flowchart for illustrating an information processing method (i.e., a motion control method of a robot) of the present embodiment. The control procedure illustrated in FIG. 10 may be stored in a storage portion of the controller 3, as a control program.

After the control (information processing) is started, a target teach point for causing the robot 1 to perform a desired motion is sent from the PLC 2 to the controller 3 in Step S100.

In Step S101, the motion-route calculation program 5 of the controller 3 determines a motion route for moving the robot 1 from a current teach point (i.e., a current position of the robot 1) to the target teach point, by using the information included in the route information map 6.

If only one route along which the robot 1 can move from the current teach point to the target teach point exists in the route information map 6, the motion-route calculation program 5 determines the route as a motion route.

In contrast, if a plurality of routes along which the robot 1 can move from the current teach point to the target teach point exists in the route information map 6, the motion-route calculation program 5 evaluates the plurality of routes (candidates) and determines an optimum route of the plurality of routes, as a motion route.

For example, if the criterion of evaluation is to determine the shortest motion route, the motion-route calculation program 5 can determine (select) the shortest motion route of the plurality of routes by graphing the routes, and solving the shortest route problem by using an algorithm such as Dijkstra’s algorithm or Bellman-Ford algorithm. However, the criterion of evaluation is not limited to determining the shortest motion route. If the cost information (i.e., various types of information such as time required for movement, distance of movement, energy required for movement, peak current) of each route is included in the route information map 6, the motion-route calculation program 5 can evaluate each route on various criteria of evaluation, by using the cost information. For example, for performing the evaluation, the motion-route calculation program 5 can select parameters, used for the evaluation, depending on an index of performance on which a user places importance for the motion of the robot performed for work; and calculate the sum of costs after weighting each parameter in accordance with the type of the parameter.

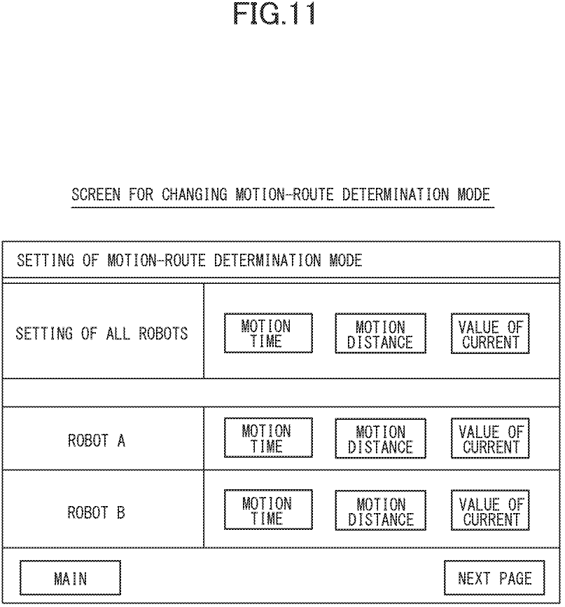

For allowing the motion-route calculation program 5 to automatically determine a motion route in accordance with an index of performance on which a user places importance, a motion-route determination mode (i.e., a criterion of evaluation) can be set in advance by using a display screen illustrated in FIG. 11 as an example. By using this screen image, a user can register an item of performance (i.e., an item of evaluation), on which the user places importance when determining a motion route of a robot, in the motion-route calculation program 5 in advance. In this example, the display screen is formed so that a user can collectively set an identical item of evaluation to a plurality of robots, or can set a different item of evaluation to an individual robot.

For example, there is a case in which the motion time of a robot A is clearly longer than the motion time of a robot B when the robots A and B perform different motions simultaneously and in parallel. In this case, a user can set a motion-route setting mode by using a display screen of FIG. 11 such that the priority for the robot A is given to shortening the motion time of the robot Afor increasing the throughput of the whole of the system, and that the priority for the robot B is given to reducing the value of current of the robot B for reducing the energy consumption. Note that in FIG. 8, the above-described process for acquiring an optimum motion route may be performed by putting the teach point P1 in the input field F8 of FIG. 8, putting the teach point P3 in the input field F9, and pressing the button F7. In this case, the optimum motion route from the teach point P1 to the teach point P3 may be highlighted by thick arrows. As an example, there may be a case in which a robot can also move from the teach point P1 to the teach point P3 via another teach point other than the teach point P2. In such a case, an optimum motion route that can be easily recognized by a user can also be displayed, even if the number of teach points is increased, by displaying the optimum motion route as described above. Note that although the thick arrows are used in the present embodiment, a teach point and an arrow may be displayed with a color different from a color of other teach points and arrows. In another case, hatch lines and dotted-line may be provided for a teach point and an arrow respectively.

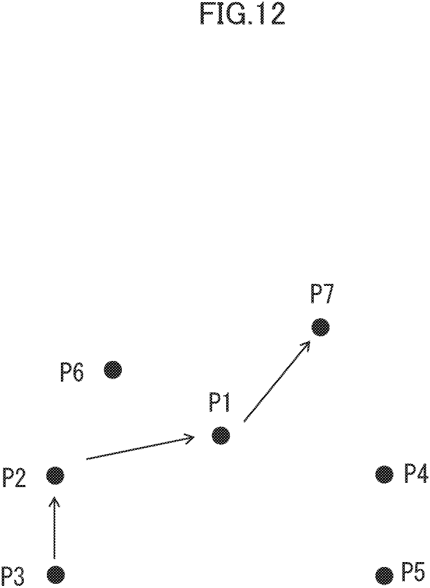

FIG. 12 illustrates one example of a motion route determined (created) in Step S101 (FIG. 10). In this example, the PLC 2 instructs the controller 3 to move the robot 1 to a target teach point P7 when the current position (current teach point) of the robot 1 is the teach point P3, and the motion-route calculation program 5 determines a motion route: P3 → P2 → P1 → P7 that passes through the intermediate teach points P2 and P1. However, since this motion route is one example, another motion route, such as a route P3 → P2 → P6 → P1 → P7, may be determined, depending on the setting of the motion-route determination mode.

In Step S102 (FIG. 10), the controller 3 creates a motion command for moving the robot 1 along the motion route determined in Step S101. The motion command is created as a variable from a target teach point and motion parameters, in conformity with a rule. Since the motion command is created as a variable, the motion of the robot can be changed without changing a program. The motion parameters may include information on an interpolation method of motion, speed, acceleration, deceleration, and stopping accuracy; and can be set, associated with a corresponding route.

In Step S103 (FIG. 10), the motion command created in Step S102 is interpreted by the motion-command reception program 4, and the motion-command reception program 4 causes the robot 1 to execute the motion command. That is, the robot 1 moves to the target teach point along the determined motion route.

The information processing illustrated in the flowchart of FIG. 10 is repeated until the operation that a user causes the robot 1 to execute is completed. Every time the information processing is repeated, a motion route along which the robot 1 will move to a target teach point indicated by the PLC 2 is determined, and the robot 1 executes the operation.

As described above, in the present embodiment, the information on motion routes that the robot can take is stored in advance as a route information map. Thus, when a target teach point is indicated by the PLC, the information processing apparatus refers to the route information map, determines a motion route, and causes the robot to execute the operation. In such a configuration, the complicated computation performed every time a target teach point is indicated for determining a motion route is not necessary, and the controller has only to read motion routes from the route information map, which the robot can take. As a result, the processing time required for determining a motion route can be reduced. For example, while the motion-command reception program 4 interprets a motion command and causes the robot 1 to execute the motion command, the controller 3 can receive information on the next target teach point from the PLC 2 and cause the motion-route calculation program 5 to determine the next motion route. Thus, in the present embodiment, the processing cycles of the motion control of the robot can be increased. In addition, since the intermediate teach points are automatically generated by only specifying a target teach point, a user can easily perform editing work, such as changing the motion of the robot.

### Information Processing in Return-to-Origin Motion

The information processing method of the present embodiment can be applied not only to a case where a robot is moved under a predetermined procedure, such as a procedure for assembly work, but also to a return-to-origin motion in which a robot is returned to an origin (i.e., a standby position) when an error occurs.

For example, there is a case in which a robot is stopped, although the robot itself has no error, when the robot receives an emergency stop command from a management portion of a manufacturing system while executing an operation.

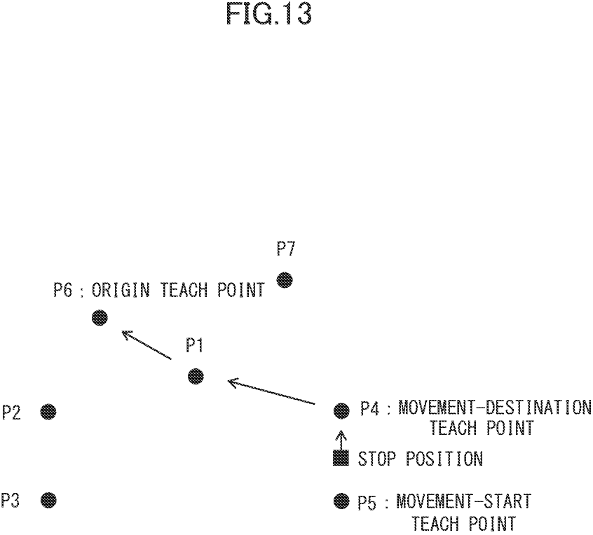

FIG. 13 illustrates an example in which a robot is stopped when the robot receives an emergency stop command while moving from a teach point P5 (i.e., a movement-start teach point) toward a teach point P4 (i.e., a movement-destination teach point). In such a case, it is common that the robot is not left at the stop position and is moved to a position (that may be referred to as an origin teach point) predetermined by a user. The robot is positioned at the origin teach point, and is put on standby until the system is restarted. In the example of FIG. 13, the origin teach point is a teach point P6.

In such a case, if a user determines a motion route of the robot from a stop position to the origin teach point every time the emergency stop command is issued, and teaches the robot the motion, it is inconvenient. In this case, it can be understood that since the robot is stopped emergently while moving from the teach point P5 toward the teach point P4, which are set in advance as a motion route, the robot can move from the stop position to the teach point P5 or the teach point P4 without interfering with any obstacle. However, for determining an optimum motion route from the stop position to the origin teach point, it is necessary to examine both of the route from the teach point P5 to the origin teach point (i.e., the teach point P6) and the route from the teach point P4 to the origin teach point (i.e., the teach point P6) on whether the robot can move along the routes.

For dealing with such a case, in the present embodiment, the information on whether a robot can move from any teach point to the origin teach point can be included in advance in the route information map.

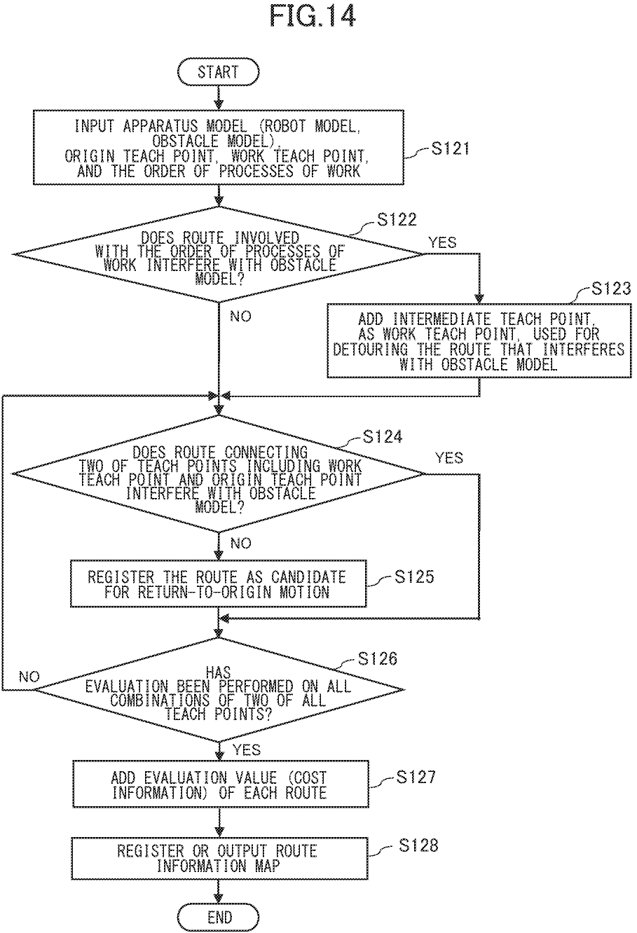

FIG. 14 is a flowchart illustrating one example of an information processing procedure for storing the information in the route information map. The program that executes the control procedure illustrated in FIG. 14 may be stored in a storage portion of the controller 3, as a control program. In another case, the program that executes the control procedure illustrated in FIG. 14 may be stored not in the robot control apparatus 200, but in an external computer, and a user may create the route information map by using the external computer.

In Step S121, a user inputs the following information into the controller 3 via a user interface. That is, a user inputs a model of the robot 1 and a model of an obstacle that exists in the work space (the model of the robot 1 and the obstacle model may be collectively called an apparatus model), an origin teach point, a target teach point and an intermediate teach point that exist on a route used for work (the target teach point and the intermediate teach point may be collectively called work teach points), and the order of processes of work. Note that a user may input a plurality of origin teach points and a plurality of work teach points into the controller 3.

In Step S122, the controller 3 determines whether the routes involved with the order of processes of the work, inputted in Step S121, interfere with the obstacle model. The controller 3 proceeds to Step S123 if a route of the routes interferes with the obstacle model (Step S122: YES), or proceeds to Step S124 if none of the routes interfere with the obstacle model (Step S122: NO).

In Step S123, the controller 3 determines an intermediate teach point via which the robot can detour the route, which has been determined in Step S122 as a route that interferes with the obstacle model; adds the intermediate teach point to the work teach points; and changes the order of processes of work so that the robot can move via the added work teach point (intermediate teach point). Note that if a plurality of routes interferes with the obstacle model, the controller 3 determines intermediate teach points via which the robot can detour the plurality of routes which have been determined in Step S122 as routes that interfere with the obstacle model; adds the intermediate teach points to the work teach points; and changes the order of processes of work so that the robot can move via the added work teach points (intermediate teach points).

As a result, in both of a case where the controller 3 proceeds from Step S122 to Step S124 via Step S123, and a case where the controller 3 directly proceeds from Step S122 to Step S124, all the motion routes, which have been registered for causing the robot to work, will not interfere with the obstacle model.

Then, the controller 3 registers motion routes that are candidates in the return-to-origin motion, in the route information map. Note that the robot can not necessary move directly from the nearest work teach point (to a position at which the robot is stopped) to the origin teach point. If the robot cannot move directly from the nearest work teach point to the origin teach point, the robot may have to move to the origin teach point via an intermediate teach point. For this reason, not only a combination of the origin teach point and a work teach point, but also a combination of work teach points is examined on whether a route that connects two teach points interferes with an obstacle, and a route that does not interfere with the obstacle is registered as a motion-route candidate in the return-to-origin motion.

In Step S124, the controller 3 selects any two points from points including the origin teach point and work teach points (that include the intermediate teach point added in Step S123), and determines whether a route that connects two points interferes with the obstacle model. If the route interferes with the obstacle model (Step S124: YES), then the controller 3 does not register the route as a motion-route candidate (that is, skips Step S125) and proceeds to Step S126 because the route cannot be adopted as a motion route in the return-to-origin motion.

On the other hand, if the route does not interfere with the obstacle model (Step S124: NO), then the controller 3 proceeds to Step S125 and registers the route as a motion-route candidate because the route can be adopted as a motion route in the return-to-origin motion.

In Step S126, the controller 3 determines whether the interference has been evaluated on all combinations of two of all the teach points including the work teach points and the origin teach point. If there is a combination of teach points on which the evaluation has still not been completed (Step S126: NO), then the controller 3 returns to Step S124 and performs the evaluation on the combination of teach points on which the evaluation has still not been completed. If the interference has been evaluated on all combinations of two teach points (Step S126: YES), then the controller 3 proceeds to Step S127, and creates an evaluation value (cost information) for each route and adds the evaluation value (cost information) to the route information map.

In Step S128, the controller 3 registers or outputs the route information map that includes all of the route information stored, and ends the information processing Note that Step S127 may be omitted, if necessary.

In the present embodiment, the apparatus model, the origin teach point, the work teach point, and the order of processes of work are inputted into the controller 3, so that the route information map that is applicable also to the return-to-origin motion can be created. In addition, even if the configuration of the apparatus is changed or a work teach point is added, the route information map can be easily edited by changing the apparatus model, the origin teach point, the work teach point, and the order of processes of work.

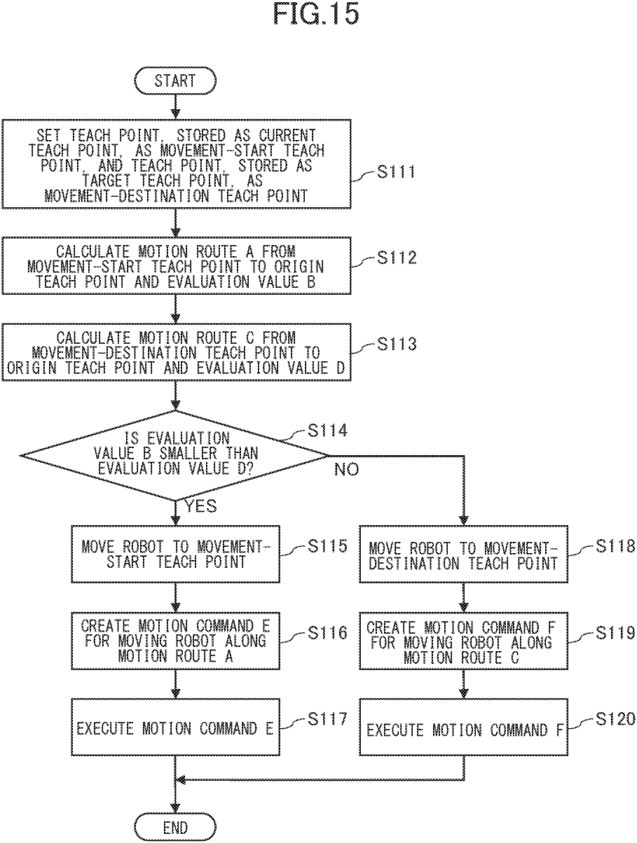

Next, with reference to a flowchart of FIG. 15, information processing performed when a return-to-origin motion is performed by using the above-described route information map will be described.

For example, in the example of FIG. 13, if a robot is stopped emergently while moving from the teach point P5 toward the teach point P4, the teach point P5 is still stored as a teach point that is control information representing a current position of the robot. If the PLC 2 instructs the controller 3 to cause the robot to perform the return-to-origin motion (that is, move the robot to the origin teach point P6) in this state, the controller 3 starts the task of the return-to-origin motion.

In Step S111, the controller 3 sets the teach point P5, stored as a current teach point, as a movement-start teach point; and sets the teach point P4, stored as a target teach point, as a movement-destination teach point.

In Step S112, the motion-route calculation program 5 assigns the movement-start teach point a start teach point at which the robot will be located first, and assigns the origin teach point a target teach point; and determines the presence of a route that does not interfere with any obstacle, by referring to the route information map 6. As in Step S101 of FIG. 10, the motion-route calculation program 5 determines not only the presence of a route that directly connects the start teach point and the target teach point, but also the presence of a route that extends from the start teach point to the target teach point via an intermediate teach point. If a route exists, the motion-route calculation program 5 determines an evaluation value of cost of the route. If a plurality of routes is extracted, the motion-route calculation program 5 selects a route that has the smallest evaluation value of cost (that is, the lowest cost). The route from the movement-start teach point to the origin teach point, which is determined in this manner and along which the robot will move, is defined as a motion route A, and the evaluation value of the motion route A is defined as an evaluation value B.

In Step S113, the motion-route calculation program 5 assigns the movement-destination teach point a start teach point, and assigns the origin teach point a target teach point; and determines the presence of a route that does not interfere with any obstacle, by referring to the route information map 6. As in Step S101 of FIG. 10, the motion-route calculation program 5 determines not only the presence of a route that directly connects the start teach point and the target teach point, but also the presence of a route that extends from the start teach point to the target teach point via an intermediate teach point. If a route exists, the motion-route calculation program 5 determines an evaluation value of cost of the route. If a plurality of routes is extracted, the motion-route calculation program 5 selects a route that has the smallest evaluation value of cost (that is, the lowest cost). The route from the movement-destination teach point to the origin teach point, which is determined in this manner and along which the robot will move, is defined as a motion route C, and the evaluation value of the motion route C is defined as an evaluation value D.

In Step S114, the motion-route calculation program 5 compares the evaluation value B calculated in Step S112 and the evaluation value D calculated in Step S113; and selects a route that has a lower cost, as a motion route in the return-to-origin motion. That is, the controller 3 proceeds to Step S115 if the evaluation value B is smaller than the evaluation value D (Step S114: YES), or proceeds to Step S118 if the evaluation value D is smaller than the evaluation value B (Step S114: NO). Note that the controller 3 proceeds to Step S115 if only the motion route A exists, or proceeds to Step S118 if only the motion route B exists.

If the controller 3 proceeds to Step S115, the controller 3 returns the robot from the stop position to the movement-start teach point. The motion control method performed when the robot is returned from the stop position to the movement-start teach point may be the same as the interpolation method which had been performed when the robot was stopped.

In Step S116, the controller 3 creates a motion command E for moving the robot along the motion route A. The motion command E is created, as in Step S102 of FIG. 10.

In Step S117, the motion-command reception program 4 interprets the motion command E created in Step S116, and causes the robot 1 to execute the motion command E. That is, the robot 1 moves from the movement-start teach point to the origin teach point. The motion command E is executed, as in Step S103 of FIG. 10.

If the controller 3 proceeds from Step S114 to Step S118, the controller 3 moves the robot from the stop position to the movement-destination teach point. The motion control method performed when the robot is moved from the stop position to the movement-destination teach point may be the same as the interpolation method which had been performed when the robot was stopped.

In Step S119, the controller 3 creates a motion command F for moving the robot along the motion route C. The motion command F is created, as in Step S102 of FIG. 10.

In Step S120, the motion-command reception program 4 interprets the motion command F created in Step S119, and causes the robot 1 to execute the motion command F. That is, the robot 1 moves from the movement-destination teach point to the origin teach point. The motion command F is executed, as in Step S103 of FIG. 10.

FIG. 13 illustrates an example in which the motion route along which the robot performs the return-to-origin motion from the stop position to the origin teach point (teach point P6) and which has the lowest cost is a route: the stop position → the movement-destination teach point (teach point P4) → the teach point P1 → the origin teach point (teach point P6).

In the present embodiment, since the route information map includes the information on whether a robot can move between any teach points without interfering with an object, the return-to-origin motion can be automatically performed, without forcing a user to perform any complicated operation, even if the robot is stopped while performing an operation.

In addition, the controller 3 can determine which of the movement-start teach point and the movement-destination teach point the robot suitably moves through to reach the origin teach point, depending on the association between the route and the order of processes of work (working process). For example, if the robot is stopped emergently when the robot is moving after the completion of assembly work of parts, the robot may interfere with the assembled parts if the robot is returned to the movement-start teach point. In such a case, the evaluation value of a route along which the robot moves via a work teach point located upstream of a teach point (in the order of operations), at which the robot has completed the assembly work, may be set such that the evaluation value causes high risk. As a result, a motion route along which the robot moves via a work teach point located downstream of the teach point, at which the robot has completed the assembly work, is automatically set, so that the robot can move to the origin teach point via the work teach point.

### Second Embodiment

In the above-described first embodiment, for causing the route information map to include the cost information, the model information on the mechanism and characteristics of a robot is stored in advance in the controller 3. In the present embodiment, however, the cost information is acquired by using a robot simulator. Hereinafter, the description will be made for hardware and a configuration of a control system that are different from those of the first embodiment. In addition, since a component identical to a component of the first embodiment has an identical structure and effect, the detailed description thereof will be omitted.

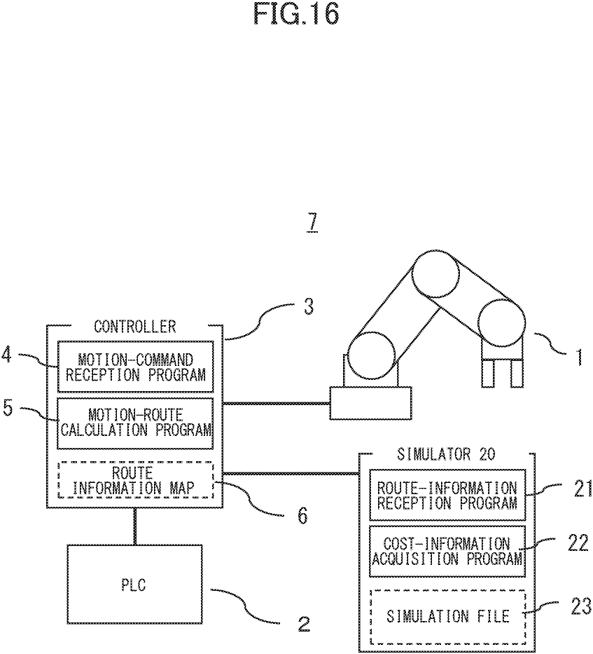

FIG. 16 is a schematic diagram for illustrating a configuration of a control system that includes an information processing apparatus of the present embodiment. A control system 7 includes a PLC 2 and a controller 3, for controlling a robot 1. In addition, a simulator 20 for acquiring the cost information is communicatively connected with the controller 3 and the route-information-map creation tool, which are included in the robot control apparatus 200.

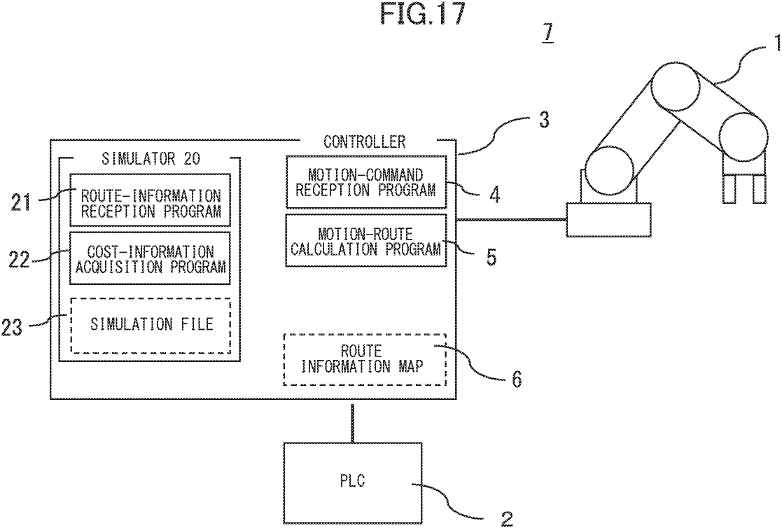

The control system of the present embodiment is not limited to the example illustrated in FIG. 16. For example, the control system may have a configuration where a single PLC controls a plurality of robots. In addition, although the description will be made for a case in which the controller 3 and the simulator 20 are connected with each other, the controller 3, the simulator 20, and the PLC 2 may be connected with each other via a bus so that they can communicate with each other. In the present embodiment, the controller 3 and the simulator 20 may be collectively called an information processing apparatus or an information processing system. Note that as illustrated in FIG. 17 as an example, the controller 3 may include the functions of the simulator 20 and the function blocks may be connected with each other via a bus.

The PLC 2 is a programmable logic controller, and outputs information on a target position (referred to also as a target teach point) to the controller 3 in a sequential manner. The target position is a position to which the robot 1 will move in the next operation. The controller 3 is communicatively connected with the PLC 2 and the robot 1, and includes a motion-command reception program 4, a motion-route calculation program 5, and a route information map 6. The motion-route calculation program 5 serves as an information processing portion.

The simulator 20 includes a route-information reception program 21, a cost-information acquisition program 22, and a simulation file 23. The route-information reception program 21 is a program that acquires the route information map 6 (e.g., the origin teach point, the work teach point, the order of processes of work, the point information, and the group information) from the controller 3 and the route-information-map creation tool. The simulation file 23 is a file, such as CAD data of the robot 1 and an obstacle, that includes the model information of the robot 1 and the data of a virtual space in which the robot 1 is virtually moved. The cost-information acquisition program 22 uses the acquired route information map 6 and the simulation file 23, simulates all combinations of motion routes along which the robot 1 can move in the route information map 6, and acquires the cost information. As described with reference to FIG. 14, the acquired motion routes are motion routes on which the robot 1 does not interfere with any obstacle in a predetermined motion. However, in a case where the cost information is needed regardless of the interference between the robot and any obstacle, the cost information may be acquired even for a motion route on which the robot 1 interferes with an obstacle.

The cost information includes information on time required for movement, movement distance (motion distance), energy required for movement, peak current, and the like. The cost-information acquisition program 22 causes the route information map 6 to include the acquired cost information, and sends the route information map 6 to the controller 3 and the route-information-map creation tool. Note that the simulator 20 receives only the route information of the route information map 6, and acquires the cost information by using the simulation file 23. In this case, the simulator 20 may send only the cost information to the controller 3 and the route-information-map creation tool, and the controller 3 and the route-information-map creation tool may cause the route information map 6 to include the cost information.

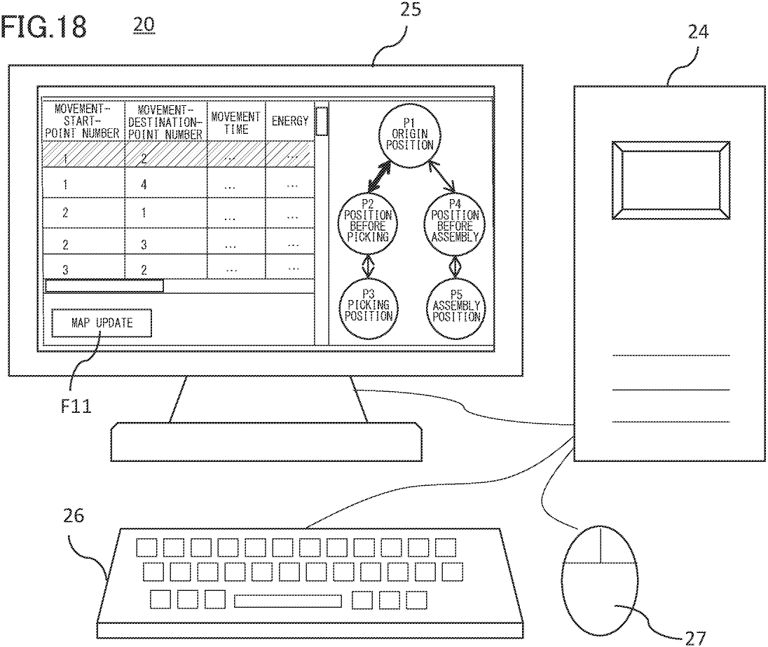

FIG. 18 is a diagram illustrating the simulator 20 of the present embodiment. The simulator 20 includes a simulator body 24 that includes the route-information reception program 21, the cost-information acquisition program 22, and the simulation file 23. In a hardware configuration, the simulator body 24 includes a CPU. In addition, the simulator body 24 includes a storage device including a ROM, a RAM, and an HDD. The ROM is a non-transitory storage device. The ROM stores a base program that is read by the CPU when the computer is started. The RAM is a transitory storage device that is used in a computing process performed by the CPU. The HDD is a non-transitory storage device that stores various types of data, such as results of a computing process performed by the CPU. In the present embodiment, the HDD stores the route-information reception program 21, the cost-information acquisition program 22, and the simulation file 23, which function as application software. The CPU can simulate the behavior of the robot 1 in a virtual environment, by executing these programs. The simulator 20 further includes a display 25 that is one example of a display connected to the simulator body 24, and a keyboard 26 and a mouse 27 that are one example of input devices connected to the simulator body 24.

Note that in the present embodiment, the HDD is a computer-readable non-transitory recording medium and stores the programs that function as application software. However, the present disclosure is not limited to this. The programs may be stored in any recording medium as long as the recording medium is a computer-readable recording medium. For example, a solid state drive (SSD), a flexible disk, an optical disk, a magneto-optical disk, a magnetic tape, a nonvolatile memory, or the like may be used as the recording medium to provide the programs to the computer.

The display 25 displays the acquired cost information in the data display field F5, and displays the route information map in the map display field F10. If any arrow of the route information map 6 or any line of the cost information is selected by using the mouse 27, a corresponding route or a corresponding piece of cost information is highlighted. In the example of FIG. 18, a route of P1 → P2 is selected, so that the arrow of the corresponding route information is displayed thicker than the other arrows and the corresponding cost information is highlighted in grayscale. If a map update button F11 is clicked, the cost information is included in the route information map 6, and the route information map 6 is sent to the controller 3 and the route-information-map creation tool. Note that the route information and the cost information may be automatically sent to the controller 3 and the route-information-map creation tool after the cost information is calculated, without being displayed on the display 25.

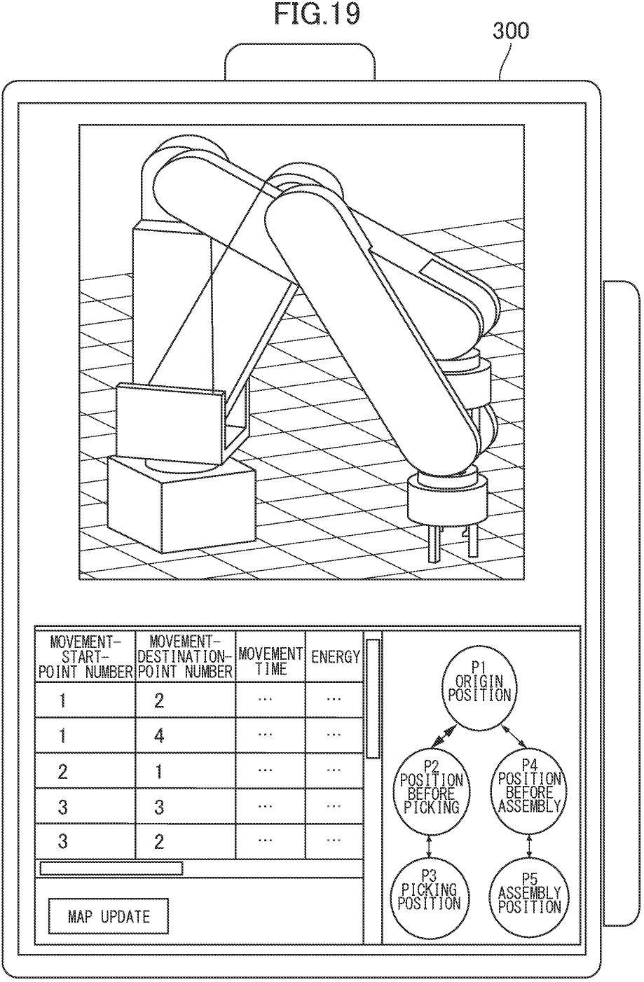

In the present embodiment, a desktop personal computer (PC) is used as the simulator 20. However, the present disclosure is not limited to this. For example, as illustrated in FIG. 19, the functions of the simulator 20 may be implemented in a tablet-type teaching pendant 300 for acquiring the cost information. In this case, a simulator image and the cost information may be displayed on the terminal device, as illustrated in FIG. 19.

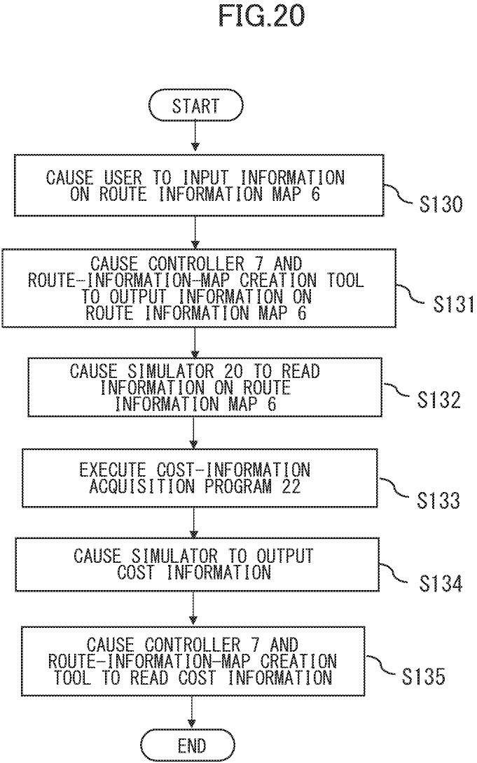

FIG. 20 illustrates a control flowchart of the present embodiment. Note that the processes of the control flowchart illustrated in FIG. 20 are performed by the controller 3 and the route-information-map creation tool cooperating and communicating with the simulator 20.

In Step S130, a user inputs the information, such as the origin teach point, the work teach point, the order of processes of work, the point information, and the group information, that is necessary for the route information map 6, by using the route-information-map creation tool.

In Step S131, the controller3 and the route-information-map creation tool output the information inputted in Step S130, to the simulator 20 in a format that can be read by the simulator 20. Specifically, the controller 3 and the route-information-map creation tool output the information on the route information map 6, as a command, so that the information on the route information map 6 can be interpreted by the route-information reception program 21 and the cost-information acquisition program 22. The data outputted is the same data as that of the route information map 6, except that the data does not include the cost information. Note that in a case where the controller 3 and the route-information-map creation tool cannot directly communicate with the simulator 20, the data may be sent to an external terminal, and via the terminal, may be sentto the simulator 20.

In Step S132, the simulator 20 executes the route-information reception program 21, and reads and stores the information of the route information map 6, such as the origin teach point, the work teach point, the order of processes of work, the point information, and the group information, which have been outputted in Step S131.

In Step S133, the simulator 20 executes the cost-information acquisition program 22, and acquires the cost information of each route of the route information map 6 through simulation. The cost-information acquisition program 22 is a program that causes the simulator to simulate the motion of a robot in each route stored in Step S132. The cost-information acquisition program 22 uses the simulation file 23, and acquires the cost information of each of routes other than the routes on which the robot 1 cannot move because of the interference between the robot and an obstacle. After completing the operation, the cost-information acquisition program 22 associates the acquired cost information with a corresponding route of the route information map 6, and stores the cost information. Note that a plurality pieces of cost information that can be acquired by the simulator may be acquired, and that the cost information may include the information on time required for movement, distance of movement, energy required for movement, and peak current, as described above.

In Step S134, the simulator 20 causes the route information map 6 to include the cost information acquired in Step S133, and sends the route information map 6 that includes the cost information to the controller 3 and the route-information-map creation tool. As in Step S131, in a case where the controller 3 and the route-information-map creation tool cannot directly communicate with the simulator 20, the data may be sent to an external terminal, and via the terminal, may be sent to the controller 3 and the route-information-map creation tool. Note that as described above, only the cost information to be included in the route information map 6 may be outputted.

In Step S135, the controller 3 and the route-information-map creation tool read the route information map 6 that includes the cost information outputted in Step S134, updates a route information map 6 that the controller 3 and the route-information-map creation tool have had, and ends the control flow. Note that as described above, the controller 3 and the route-information-map creation tool may acquire only the cost information, and cause the route information map 6 to include the cost information.

As described above, in the present embodiment, the cost information is acquired by the simulator 20. In such a configuration, since the cost information can be easily acquired by the simulator and can be included in the route information map 6, the burden of a user can be reduced.

### Modification

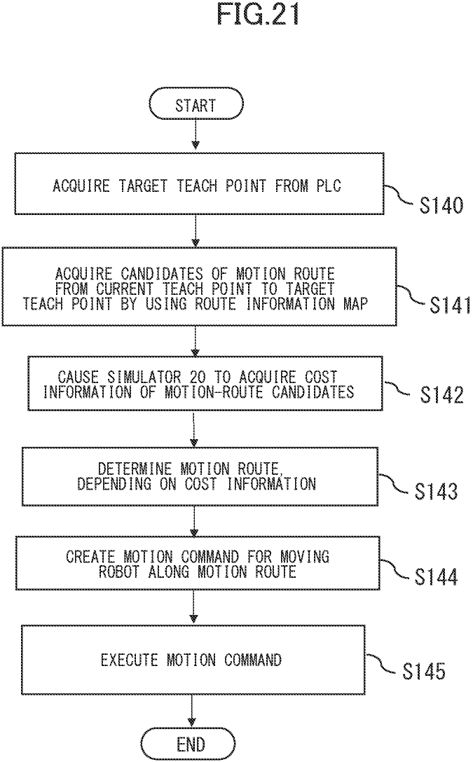

In the present embodiment, the cost information is included in the route-information-map 6. However, the present disclosure is not limited to this. For example, the simulator 20 may acquire the cost information in a sequential manner, depending on an instruction from the PLC 2. FIG. 21 illustrates a control flowchart of a modification of the present embodiment. Note that the processes of the control flowchart illustrated in FIG. 21 are performed by the PLC 2, the controller 3 and the route-information-map creation tool, and the simulator 20 cooperating and communicating with each other.

As illustrated in FIG. 21, in Step S140, after the control (information processing) is started, a target teach point for causing the robot 1 to perform a desired motion is sent from the PLC 2 to the controller 3.

In Step S141, the motion-route calculation program 5 of the controller 3 acquires a motion-route candidate for moving the robot 1 from a current teach point (i.e., a current position of the robot 1) to the target teach point, by using the route information map 6 that does not include the cost information. If a plurality of routes along which the robot 1 can move from the current teach point to the target teach point exist in the route information map 6, the motion-route calculation program 5 acquires the plurality of routes (candidates). If only one route along which the robot 1 can move from the current teach point to the target teach point exists in the route information map 6, the motion-route calculation program 5 determines the route as a motion route.

In Step S142, the controller 3 sends the plurality of motion-route candidates to the simulator 20, and the simulator 20 acquires the cost information for each motion-route candidate by using the simulation file 23, and associates the motion-route candidate with the cost information.

In Step S143, the controller 3 acquires the motion-route candidates and the cost information from the simulator 20 and evaluates them, and determines a motion route along which the robot 1 will move. In this manner, the cost information may be sequentially acquired by using the simulator 20 every time an instruction is issued from the PLC 2.

In Step S144, the controller 3 creates a motion command for moving the robot 1 along the motion route determined in Step S143. The motion command is created as a variable from a target teach point and motion parameters, in conformity with a rule. Since the motion command is created as a variable, the motion of the robot can be changed without changing a program. The motion parameters may include information on an interpolation method of motion, speed, acceleration, deceleration, and stopping accuracy; and can be set, associated with a corresponding route.

In Step S145, the motion command created in Step S144 is interpreted by the motion-command reception program 4, and the motion-command reception program 4 causes the robot 1 to execute the motion command. That is, the robot 1 moves to the target teach point along the determined motion route. As described above, since the cost information is acquired by using the simulator 20 every time an instruction is issued from the PLC 2, the present invention can be embodied even if the route information map 6 does not include the cost information.

### Third Embodiment

Next, a third embodiment will be described in detail. In the present embodiment, a teach point that a robot is prohibited from passing through is set in advance in the return-to-origin motion, in the route-information-map creation tool. Thus, an appropriate route along which the robot will move to the origin teach point can be determined in consideration of the teach point that the robot is prohibited from passing through. Hereinafter, the description will be made with reference to the drawings, for hardware and a configuration of a control system that are different from those of the first embodiment. In addition, since a component identical to a component of the first embodiment has an identical structure and effect, the detailed description thereof will be omitted.

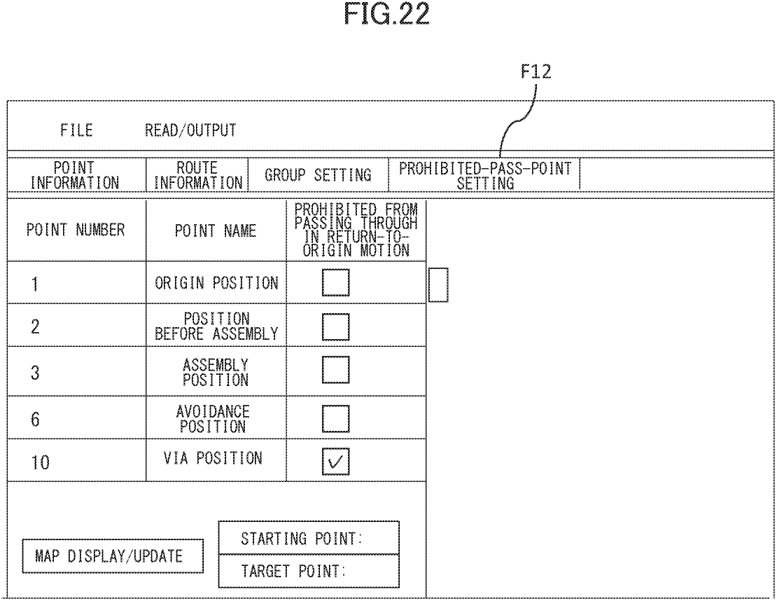

FIG. 22 illustrates an example of a screen image displayed when a prohibited-pass-point setting tab F12 of the present embodiment is selected. As illustrated in FIG. 22, if the prohibited-pass-point setting tab F12 is selected, a check box for setting a teach point that the robot 1 is prohibited from passing through in the return-to-origin motion is displayed at a corresponding teach point in the data display field F5. In the example of FIG. 22, a check mark is set in a check box that corresponds to a teach point having a point number of 10 and a point name of “position of pass point”. In this manner, a teach point that the robot is prohibited from passing through in the return-to-origin motion is suitably set in a user interface, such as the route-information-map creation tool.

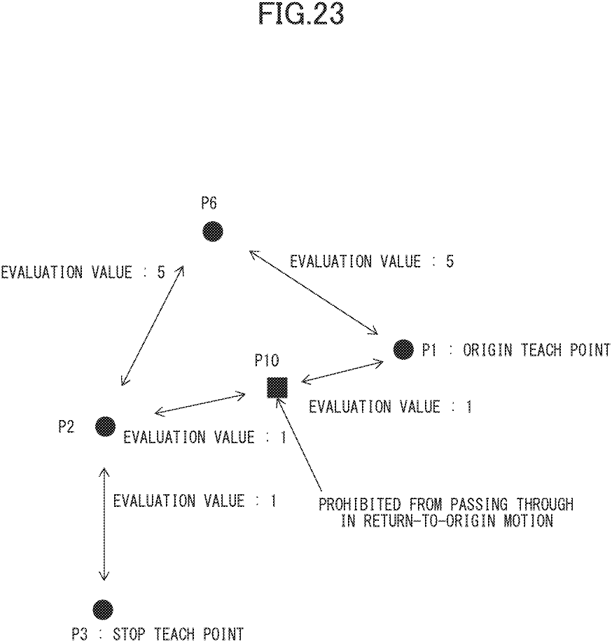

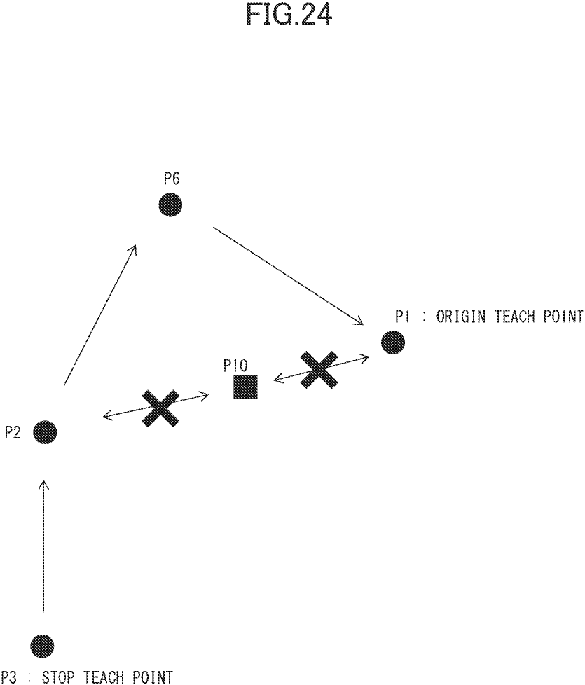

Next, a method of determining a route by using the route information map 6 will be described in detail. The route to be determined is a route along which the robot 1 will move in a state where a teach point that the robot 1 is prohibited from passing through is set. FIG. 23 illustrates an example in which a teach point P10 is set as a teach point that the robot 1 is prohibited from passing through in the return-to-origin motion. In addition, in the example of FIG. 23, a stop teach point P3 is a teach point at which the robot 1 is stopped. In a case where the return-to-origin motion is performed from the stop teach point P3 to the origin teach point P1, if a motion route is determined by using evaluation values of cost information alone, a route: the stop teach point P3 →the teach point P2 → the teach point P10 → the origin teach point P1 will be determined as a motion route. In the present embodiment, however, the teach point P10 is a teach point that the robot 1 is prohibited from passing through in the return-to-origin motion. Thus, a route illustrated in FIG. 24: the teach point P3 → the teach point P2 → the teach point P6 → the origin teach point (teach point P1) is determined as a motion route. The motion route determined is a route on which the robot 1 does not pass through the teach point P10 and which has the smallest evaluation value. The return-to-origin motion can be performed by the controller 3 performing the above-described determination in Step S101 of the control flowchart of FIG. 10.

As described above, the controller 3 can determine which of the movement-start teach point and the movement-destination teach point the robot suitably moves through to reach the origin teach point, depending on the association between the route and the order of processes of work (working process) of the robot 1. For example, if the robot 1 is stopped emergently when the robot 1 is moving after the completion of assembly work of parts, the robot 1 may interfere with the assembled parts if the robot 1 is returned to the movement-start teach point. In such a case, if the teach point at which the robot 1 has completed assembling parts is set as a teach point that the robot 1 is prohibited from passing through, it is possible to move the robot 1 such that the possibility of damaging the parts can be reduced.

As described above, in the present embodiment, a teach point that the robot is prohibited from passing through in the return-to-origin motion is set in advance. Thus, a motion route for a normal operation of assembly work or the like and a motion route for the return-to-origin motion are changed, and a motion route that reduces the possibility of damaging parts in the return-to-origin motion can be determined.

### Other Embodiments

The present invention is not limited to the above-described embodiments and examples, and may be variously modified within the technical concept of the present invention. In addition, the above-described various embodiments and modifications may be combined with each other and embodied.

In the above-described examples, for creating a route information map, a route connecting two teach points is examined on whether the route interferes with an obstacle, the route is registered as a motion-route candidate if the route does not interfere with an obstacle, and the evaluation value (cost information) of the route is stored. However, another method may be used. For example, all routes that connect two teach points may be extracted as motion-route candidates. In this case, a route of the motion-route candidates that interferes with an obstacle may be associated with an evaluation value equal to or larger than a predetermined threshold value, and may be stored in the route information map. In addition to this, when a motion route is determined, the motion-route calculation program 5 may select a motion route from among all the routes registered in the route information map, that has the smallest evaluation value in the other motion routes having evaluation values smaller than the predetermined threshold value.

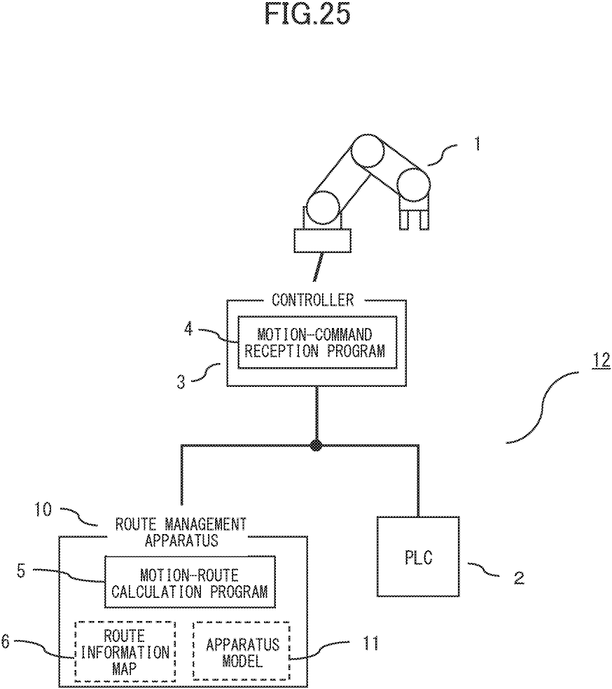

In addition, although all the functions are included in the single controller 3, in FIG. 1, for building the information processing system (control system), not all the functions may be included in the single controller 3. For example, the information processing system (control system) may be configured as illustrated in FIG. 25. In a control system 12 illustrated in FIG. 25, the controller 3 includes the motion-command reception program 4 alone, and mainly has a function for moving the robot 1. On the other hand, a route management apparatus 10 has a function for managing routes. The route management apparatus 10 includes an apparatus model 11 (i.e., a model of the robot 1 and a model of an obstacle that exists in the work space), and creates and manages the route information map 6. In addition, the route management apparatus 10 also includes the motion-route calculation program 5, and determines a motion route along which the robot moves to a target teach point indicated by the PLC 2, by using the information included in the route information map 6.

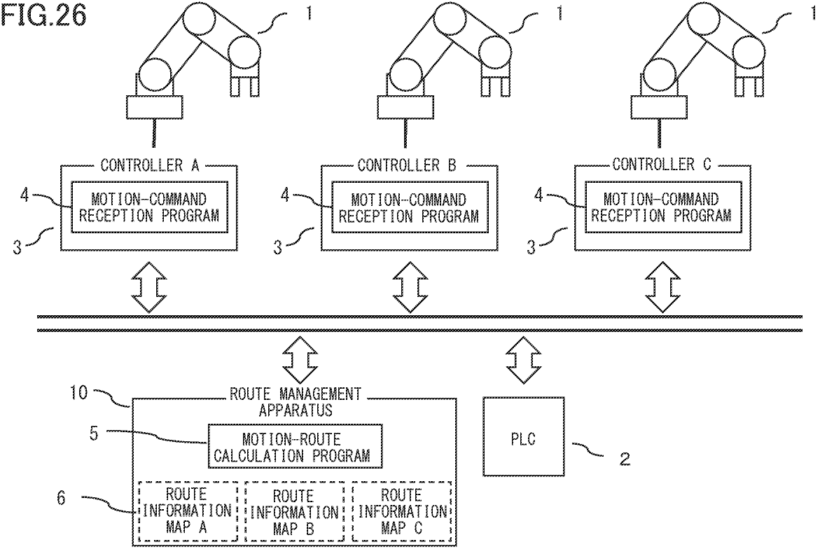

In another case, as illustrated in FIG. 26, the controller 3 may be disposed for each of a plurality of robots 1, and the single route-management apparatus 10 may control the whole system. If each of the robots has identical specifications and performs identical work in an identical environment, the motion route of the robots may be created by using a single route-information map 6; if not, a route information map 6 is individually created for each of the robots.

The motion of a robot to which the information processing method or the information processing apparatus of the present invention is applied is typically a motion for a process of manufacturing products, such as assembly, conveyance, machining (including cutting, griding, drilling, coating, bonding and welding), and cleaning of parts. However, the information processing method or the information processing apparatus of the present invention may be applied to other motions of the robot.

The information processing method and the information processing apparatus of the present invention is applicable not only to production facilities, but also to controlling of various machines and facilities including industrial robots, service robots, machine tools operated under the numerical control performed by a computer. For example, the information processing method and the information processing apparatus of the present disclosure can be applied to machines or facilities that can automatically perform expansion and contraction motion, bending and stretching motion, up-and-down motion, right-and-left motion, pivot motion, or combination motion thereof, under the control performed by the information processing apparatus.

Each of the functional elements illustrated in the drawings, which have been referred to in the above description, is illustrated so that the function of the element can be conceptually understood. Thus, it is not necessary that the functional elements are physically connected with each other as illustrated in the drawings. For example, the specific configuration of the distribution or unification of the functional blocks is not limited to the examples illustrated in the drawings, and part or all of the functional blocks may be functionally or physically distributed or unified in any unit, depending on a condition of use or the like.

The present invention can also be embodied by providing a program, which performs one or more functions of the above-described embodiments, to a system or a device via a network or a storage medium, and by one or more processors, which are included in the system or the device, reading and executing the program. In addition, the present invention can also be embodied by using a circuit, such as an ASIC, which performs one or more functions.

The disclosure of the present specification includes configurations and methods described in the following items.

### Configuration 1

An information processing apparatus comprising:
an information processing portion; and
a route information map configured to include information on a route between a plurality of teach points for a motion of a robot,
wherein the information processing portion is configured to acquire a motion route of the robot leading to a target teach point, by using information on the target teach point to which the robot is to move, and the route information map.

### Configuration 2

The information processing apparatus according to configuration 1, wherein the route information map is configured to include information on an order of motions of the robot to be performed between the teach points.

### Configuration 3

The information processing apparatus according to configuration 1 or 2, wherein the teach points of the route information map are set in advance.

### Configuration 4

The information processing apparatus according to any one of configurations 1 to 3, wherein the information on the route included in the route information map is information on the route between the teach points on which the robot is able to move without interfering with any obstacle.

### Configuration 5

The information processing apparatus according to any one of configurations 1 to 4, wherein the information processing portion is configured to acquire the motion route by using information on a current position of the robot, information on the target teach point, and the route information map.

### Configuration 6

The information processing apparatus according to any one of configurations 1 to 4, wherein the information processing portion is configured to acquire the motion route by using information on a start teach point at which the robot is to be positioned first, information on the target teach point, and the route information map.

### Configuration 7

The information processing apparatus according to any one of configurations 1 to 6, wherein the route information map is configured to include evaluation information of the route.

### Configuration 8

The information processing apparatus according to configuration 7, wherein the information processing apparatus includes a robot simulator, and wherein the information processing portion is configured to acquire the evaluation information by using the robot simulator.

### Configuration 9

The information processing apparatus according to configuration 8, wherein the information processing portion is configured to display the evaluation information, acquired by using the robot simulator, on a display portion.

### Configuration 10

The information processing apparatus according to configuration 8 or 9, wherein the information processing apparatus is configured to cause the route information map to include the evaluation information acquired by using the robot simulator.

### Configuration 11

The information processing apparatus according to any one of configurations 8 to 10, wherein the information processing apparatus is configured to highlight the route of the route information map and the evaluation information that are associated with each other.

### Configuration 12

The information processing apparatus according to configuration 9, wherein the display portion is disposed in a PC or a tablet-type teaching pendant.

### Configuration 13

The information processing apparatus according to any one of configurations 7 to 12, wherein the evaluation information includes at least one of motion time, motion distance, energy, and current value of the motion of the robot.

### Configuration 14

The information processing apparatus according to any one of configurations 7 to 13, wherein the information processing apparatus is configured to set the evaluation information used when the motion route is acquired.

### Configuration 15

The information processing apparatus according to any one of configurations 1 to 14, wherein the information processing portion is configured to acquire the route information map by using positional information of the plurality of teach points, a model of the robot, a model of an obstacle that exists in a work space of the robot.

### Configuration 16

The information processing apparatus according to any one of configurations 1 to 15, wherein the plurality of teach points includes an origin teach point that is a standby position of the robot, and wherein in a case where the robot is stopped on the motion route, the information processing portion acquires a motion route for moving the robot from a stop position of the robot to the origin teach point, by using information on the stop position and the route information map.

### Configuration 17

The information processing apparatus according to any one of configurations 1 to 15, wherein the plurality of teach points includes an origin teach point that is a standby position of the robot,
wherein in a case where the robot is stopped at a predetermined position on the motion route, the information processing portion is configured to move the robot from the predetermined position to the origin teach pointby using the route information map, and
wherein the information processing portion is configured to set a teach point included in the route information map to a point that the robot is prohibited from passing through in advance.

### Method 18

A method of manufacturing products, the method comprising:
acquiring a motion route of the robot that executes a manufacturing process of products, by using the information processing apparatus according to any one of configurations 1 to 17; and
moving the robot along the motion route.

### Method 19

An information processing method comprising: acquiring, by an information processing portion, a motion route of a robot leading to a target teach point to which the robot is to move, by using information on the target teach point, and a route information map that includes information on a route between a plurality of teach points for a motion of the robot.

### Configuration 20

A program that causes a computer to execute the information processing method according to method 19.

### Configuration 21

A computer-readable recording medium storing the program according to configuration 20.

### Configuration 22

A system comprising:
a robot;
an information processing apparatus including a route information map configured to include information on a route between a plurality of teach points for a motion of the robot; and
a PLC configured to output information on a target teach point to which the robot is to move, to the information processing apparatus.

### Configuration 23

An information processing apparatus comprising:
an information processing portion; and
a route information map configured to include information on a route between a plurality of teach points for a motion of a robot,
wherein the information processing portion is configured to display a motion route of the robot leading to a target teach point, on a display portion by using information on the target teach point to which the robot is to move, and the route information map.

### Method 24

An information processing method comprising: displaying by an information processing apparatus, a motion route of a robot leading to a target teach point to which the robot is to move, on a display portion by using information on the target teach point, and a route information map that includes information on a route between a plurality of teach points for a motion of the robot.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g, central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Pat. Application No. 2021-165899, filed Oct. 8, 2021, and Japanese Pat. Application No. 2022-134897, filed Aug. 26, 2022, which are hereby incorporated by reference herein in their entirety.

What is claimed is:

1. An information processing apparatus comprising:
an information processing portion; and
a route information map configured to include information on a route between a plurality of teach points for a motion of a robot,
wherein the information processing portion is configured to acquire a motion route of the robot leading to a target teach point, by using information on the target teach point to which the robot is to move, and the route information map.

2. The information processing apparatus according to claim 1, wherein the route information map is configured to include information on an order of motions of the robot to be performed between the teach points.

3. The information processing apparatus according to claim 1, wherein the teach points of the route information map are set in advance.

4. The information processing apparatus according to claim 1, wherein the information on the route included in the route information map is information on the route between the teach points on which the robot is able to move without interfering with any obstacle.

5. The information processing apparatus according to claim 1, wherein the information processing portion is configured to acquire the motion route by using information on a current position of the robot, information on the targetteach point, and the route information map.

6. The information processing apparatus according to claim 1, wherein the information processing portion is configured to acquire the motion route by using information on a start teach point at which the robot is to be positioned first, information on the target teach point, and the route information map.

7. The information processing apparatus according to claim 1, wherein the route information map is configured to include evaluation information of the route.

8. The information processing apparatus according to claim 7, wherein the information processing apparatus includes a robot simulator, and
wherein the information processing portion is configured to acquire the evaluation information by using the robot simulator.

9. The information processing apparatus according to claim 8, wherein the information processing portion is configured to display the evaluation information, acquired by using the robot simulator, on a display portion.

10. The information processing apparatus according to claim 8, wherein the information processing apparatus is configured to cause the route information map to include the evaluation information acquired by using the robot simulator.

11. The information processing apparatus according to claim 9, wherein the information processing apparatus is configured to highlight the route of the route information map and the evaluation information that are associated with each other.

12. The information processing apparatus according to claim 9, wherein the display portion is disposed in a PC or a tablet-type teaching pendant.

13. The information processing apparatus according to claim 7, wherein the evaluation information includes at least one of motion time, motion distance, energy, and current value of the motion of the robot.

14. The information processing apparatus according to claim 7, wherein the information processing apparatus is configured to set the evaluation information used when the motion route is acquired.

15. The information processing apparatus according to claim 1, wherein the information processing portion is configured to acquire the route information map by using positional information of the plurality of teach points, a model of the robot, a model of an obstacle that exists in a work space of the robot.

16. The information processing apparatus according to claim 1, wherein the plurality of teach points includes an origin teach pointthat is a standby position of the robot, and
wherein in a case where the robot is stopped on the motion route, the information processing portion acquires a motion route for moving the robot from a stop position of the robot to the origin teach point, by using information on the stop position and the route information map.

17. The information processing apparatus according to claim 1, wherein the plurality of teach points includes an origin teach pointthat is a standby position of the robot,
wherein in a case where the robot is stopped at a predetermined position on the motion route, the information processing portion is configured to move the robot from the predetermined position to the origin teach point by using the route information map, and
wherein the information processing portion is configured to set a teach point included in the route information map to a point that the robot is prohibited from passing through in advance.

18. A method of manufacturing products, the method comprising:
acquiring a motion route of the robot that executes a manufacturing process of products, by using the information processing apparatus according to claim 1; and
moving the robot along the motion route.

19. An information processing method comprising:
acquiring, by an information processing portion, a motion route of a robot leading to a target teach point to which the robot is to move, by using information on the target teach point, and a route information map that includes information on a route between a plurality of teach points for a motion of the robot.

20. A computer-readable recording medium storing a program that causes a computer to execute the information processing method according to claim 19.

21. A system comprising:
a robot;
an information processing apparatus including a route information map configured to include information on a route between a plurality of teach points for a motion of the robot; and
a PLC configured to output information on a target teach point to which the robot is to move, to the information processing apparatus.

22. An information processing apparatus comprising:
an information processing portion; and
a route information map configured to include information on a route between a plurality of teach points for a motion of a robot,
wherein the information processing portion is configured to display a motion route of the robot leading to a target teach point, on a display portion by using information on the target teach point to which the robot is to move, and the route information map.

23. An information processing method comprising:
displaying by an information processing apparatus, a motion route of a robot leading to a target teach point to which the robot is to move, on a display portion by using information on the target teach point, and a route information map that includes information on a route between a plurality of teach points for a motion of the robot.
